(19) United States
(12) Patent Application Publication
(10) Pub. No.: US 2013/0266208 A1
(43) Pub. Date: Oct. 10, 2013

(54) IMAGE PROCESSING APPARATUS AND METHOD

(71) Applicants: Hwa Sup Lim, Yongin-si (KR); Yong Sun Kim, Yongin-si (KR); Kee Chang Lee, Yongin-si (KR); Seung Kyu Lee, Yongin-si (KR); Ouk Choi, Yongin-si (KR)

(72) Inventors: Hwa Sup Lim, Yongin-si (KR); Yong Sun Kim, Yongin-si (KR); Kee Chang Lee, Yongin-si (KR); Seung Kyu Lee, Yongin-si (KR); Ouk Choi, Yongin-si (KR)

(73) Assignee: SAMSUNG ELECTRONICS CO., LTD., Suwon (KR)

(21) Appl. No.: 13/816,433

(22) PCT Filed: Aug. 10, 2011
(86) PCT No.: PCT/KR2011/005824

§ 371 Date: Jun. 25, 2013

(30) Foreign Application Priority Data
Aug. 10, 2010 (KR) 10-2010-0076892
Aug. 9, 2011 (KR) 10-2011-0079006

(51) Int. Cl. G06T 7/00

(52) U.S. Cl. CPC G06T 7/0083
USPC 382/154

(57) ABSTRACT

Provided is an image processing apparatus. A boundary detector of the image processing apparatus may detect a boundary of an occlusion region of a color image warped in correspondence to a first view. A boundary labeling unit of the image processing apparatus may label the detected boundary with one of a foreground region boundary and a background region boundary.

### CROSS-REFERENCE TO RELATED APPLICATIONS

This application is a U.S. National Phase application of International Application No. PCT/KR2011/005824 filed on Aug. 10, 2011, and which claims the priority benefit of Korean Patent Application No. 10-2010-0076892 filed on Aug. 10, 2010 in the Korean Intellectual Property Office, and Korean Patent Application No. 10-2011-0079006 filed on Aug. 9, 2011 in the Korean Intellectual Property Office, the contents of each of which are incorporated herein by reference.

### BACKGROUND

1. Field

Example embodiments of the following description relate to an image processing apparatus and method that may warp a two-dimensional (2D) image and perform color inpainting of an occlusion region in order to generate a three-dimensional (3D) image.

2. Description of the Related Art

Currently, interest regarding a three-dimensional (3D) image is increasing. The 3D image may be configured by providing images corresponding to a plurality of views. For example, the 3D image may be a multi-view image corresponding to the plurality of views, a stereoscopic image that provides a left eye image and a right eye image corresponding to two views, and the like.

The 3D image may be captured at different views or be rendered and then be provided. Also, the 3D image may be provided through image processing of a pre-generated two-dimensional (2D) image and a view transformation.

For the above image processing, a process of warping each of regions of a 2D color image based on a distance from each view, and inpainting a color value of an occlusion region, in which color information is absent, may be used. Warping may be understood as shifting of applying a modification with respect to each of regions of a color image based on a distance from each view, and the like.

In a conventional art, due to accuracy that is degraded while performing color inpainting of an occlusion region in which color information is absent in a warped color image, the quality of a view transformation has been degraded.

### SUMMARY

Additional aspects and/or advantages will be set forth in part in the description which follows and, in part, will be apparent from the description, or may be learned by practice of the disclosure.

Example embodiments provide an image processing apparatus and method that may provide an errorless view transformed image by enhancing the color inpainting quality of an occlusion region that is disoccluded during a warping process.

Example embodiments also provide an image processing apparatus and method that may perform errorless natural color inpainting, even though a region having a plurality of distance levels from a view is included within an occlusion region that is disoccluded during a warping process.

The foregoing and/or other aspects are achieved by providing an image processing apparatus, including a boundary detector to detect a boundary of an occlusion region of a color image warped in correspondence to a first view, and a boundary labeling unit to label the detected boundary with one of a foreground region boundary and a background region boundary.

The image processing apparatus may further include an image warping unit to shift at least a portion of an input color image corresponding to a second view using an input depth image corresponding to the second view, and to provide the warped color image to the boundary detector.

The boundary labeling unit may secondarily differentiate the input depth image, and label the boundary of the occlusion region of the warped color image with one of the foreground region boundary and the background region boundary, based on the secondary differentiation result.

The boundary labeling unit may employ a Laplacian operator when secondarily differentiating the input depth image.

The boundary labeling unit may label the boundary of the occlusion region of the warped color image with one of the foreground region boundary and the background region boundary, depending on whether the boundary of the occlusion region corresponds to a falling edge or a rising edge based on the secondary differentiation result.

The boundary labeling unit may label the detected boundary with one of the foreground region boundary and the background region boundary, using an inner product between a gradient vector of the input depth image and an occlusion direction vector of the warped color image.

The boundary labeling unit may label at least a portion of the detected boundary corresponding to a negative inner product with the foreground region boundary, and may label at least a portion of the detected boundary corresponding to a positive inner product with the background region boundary.

The boundary labeling unit may increase a reliability weight of the inner product, according to an increase in at least one scalar value, among the gradient vector of the input depth image and the occlusion direction vector of the warped color image.

The boundary labeling unit may increase the reliability weight, according to an increase in a similarity between an inner product that is computed in correspondence to a first point in the detected boundary and an inner product that is computed in correspondence to a neighbor point of the first point.

The image processing apparatus may further include an inpainting direction determining unit to determine an inpainting direction of the occlusion region of the warped color image from a direction of the background region boundary to a direction of the foreground region boundary, based on the labeling result with respect to the boundary of the occlusion region of the warped color image.

The image processing apparatus may further include an inpainting unit to generate a result color image in which a color value of the occlusion region of the warped color image is recovered by performing color inpainting along the determined inpainting direction.

The inpainting direction determining unit may determine the inpainting direction, based on at least one of an edge strength of the detected boundary, a depth value of the input depth image corresponding to the occlusion region of the warped color image, and a distance from the detected boundary of the occlusion region of the warped color image.

The boundary detector may detect the boundary of the occlusion region of the warped color image using a morphological operation, and/or may detect the boundary of the occlusion region of the warped color image using a chain code process.

The foregoing and/or other aspects are achieved by providing an image processing method, including detecting a boundary of an occlusion region of a color image warped in correspondence to a first view, and labeling the detected boundary with one of a foreground region boundary and a background region boundary.

According to embodiments, an errorless view transformed image may be provided by enhancing the color inpainting quality of an occlusion region disoccluded during a warping process.

Also, according to embodiments, even though an occlusion region disoccluded during a warping process includes a region having a plurality of distance levels from a view, errorless natural color inpainting may be performed.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an image processing apparatus, according to an example embodiment;

FIG. 2 illustrates a color image and a depth image input that are input into the image processing apparatus, according to an example embodiment;

FIG. 3 illustrates a warped color image including an occlusion region disoccluded by warping the color image of FIG. 2, according to an example embodiment;

FIG. 4 illustrates a result of the image processing apparatus extracting a boundary of an occlusion region from the warped color image of FIG. 3, according to an example embodiment;

FIG. 5 illustrates an image to describe a process of the image processing apparatus labeling the boundary of the occlusion region of FIG. 4, according to an example embodiment;

FIG. 6, parts (a), (b), (c), and (d) illustrate a process of the image processing apparatus labeling the boundary of the occlusion region of FIG. 4, according to another example embodiment;

FIG. 7 illustrates a graph to describe a process of determining a boundary value of an occlusion region, according to an example embodiment;

FIG. 8 illustrates an image in which labeling is performed with respect to a boundary of an occlusion region, according to an example embodiment;

FIG. 9 illustrates an image to describe a process of the image processing apparatus determining a color inpainting direction, according to an example embodiment;

FIG. 10 illustrates a result image of color inpainting with respect to the occlusion region of the warped color image of FIG. 3, according to an example embodiment;

FIG. 11 illustrates a color image that is inputted into the image processing apparatus, according to an example embodiment;

FIG. 12 illustrates a process of inpainting an occlusion region of a warped color image corresponding to the color image of FIG. 11, according to an example embodiment; and

FIG. 13 illustrates an image processing method, according to an example embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

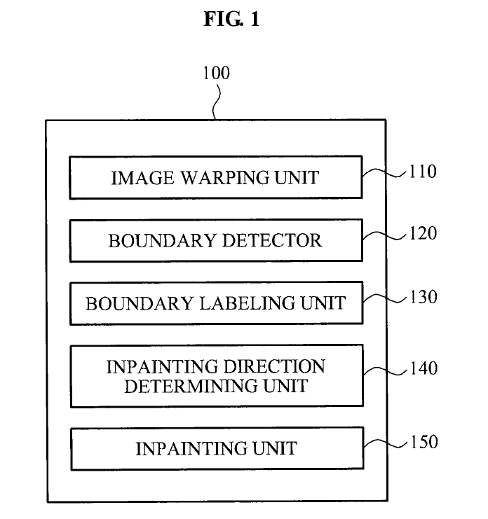

FIG. 1 illustrates an image processing apparatus, according to an embodiment.

The image processing apparatus 100 may include an image warping unit 110 to warp an input color image, based on a view distance between a second view corresponding to an input depth image and an input color image and a first view that is a target view at which a view transformed image is desired to be generated. During the above process, a depth value identified from the input depth image may be used to determine a shifting level of a warping process.

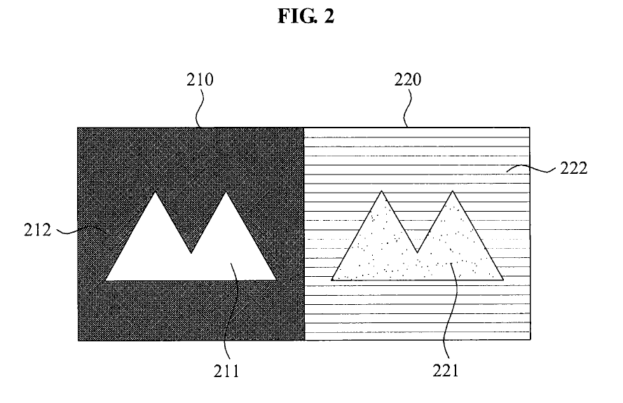

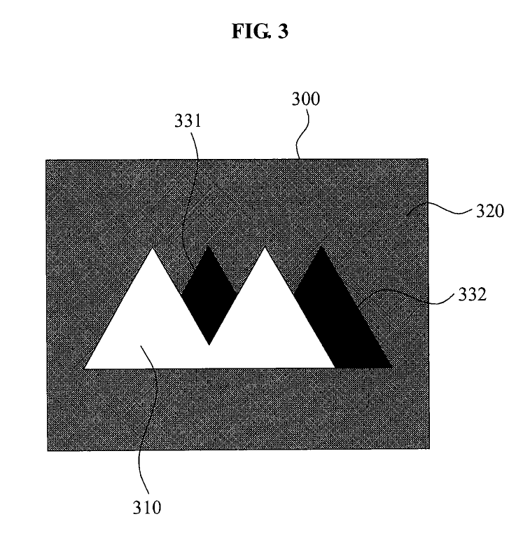

An operation of the image warping unit 110 will be further described with reference to FIG. 2 and FIG. 3.

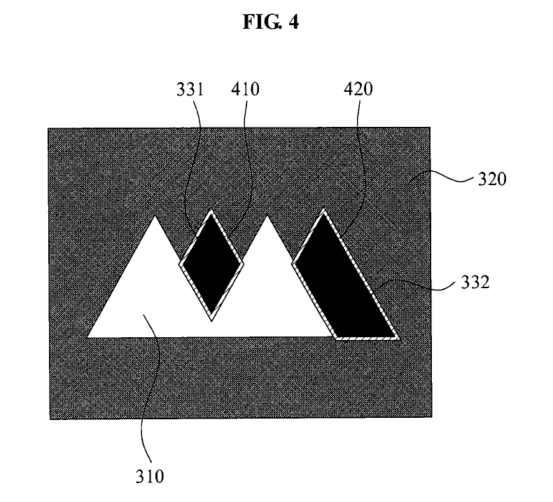

A boundary detector 120 of the image processing apparatus 100 may extract a boundary of an occlusion region disoccluded in a warped color image. The boundary may be extracted by employing a variety of conventional image processing methods of extracting a region boundary. Various embodiments related thereto will be further described with reference to FIG. 4.

A boundary labeling unit 130 of the image processing apparatus 100 may determine whether each portion of the extracted boundary corresponds to a boundary with a foreground region or a boundary with a background region and thereby perform labeling with respect to each region of the extracted boundary.

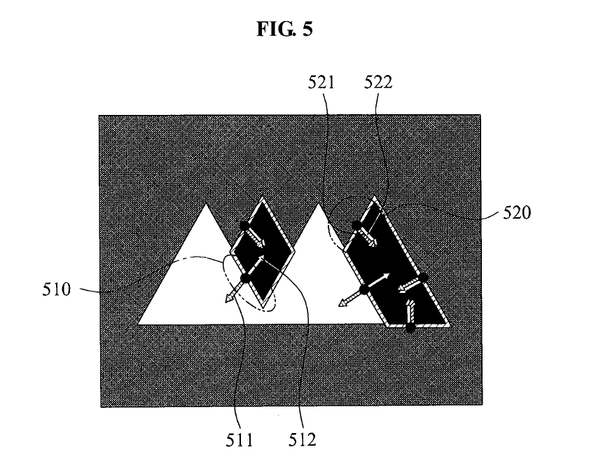

An operation and embodiments of the boundary labeling unit 130 will be further described with reference to FIG. 5 through FIG. 8.

When boundary labeling is performed, an inpainting direction determining unit 140 of the image processing apparatus 100 may determine an inpainting direction from a direction of the boundary that makes contact with the background region to a direction of the boundary that makes contact with the foreground region.

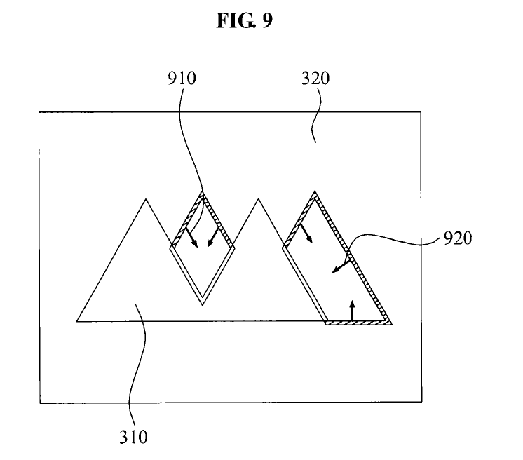

An operation of the inpainting direction determining unit 140 will be further described with reference to FIG. 9.

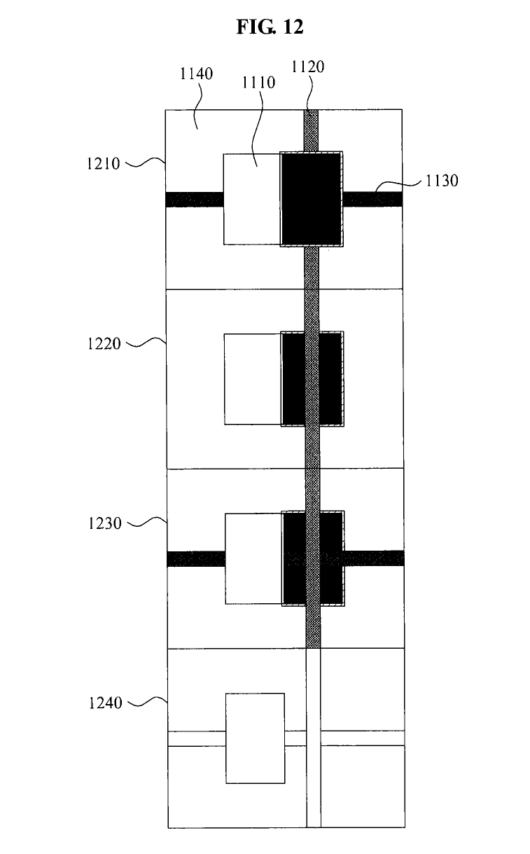

An inpainting unit 150 of the image processing apparatus 100 may perform color inpainting along the determined inpainting direction. During the above process, a plurality of layers within the occlusion region may be expressed by varying a priority of color inpainting in each boundary region, which will be further described with reference to FIG. 11 and FIG. 12.

FIG. 2 illustrates a color image and a depth image that are inputted into the image processing apparatus 100, according to an example embodiment.

The input depth image 210 may correspond to an image that is captured at a second view with a depth camera using an infrared (IR) light, and the like, and may have a difference in a brightness based on a distance from the second view. A foreground region 211 is closer to the second view compared to a background region 212, and thus, may be expressed using a bright value.

The input color image 220 may correspond to an image that is captured at the second view using a general color camera, and may include color information corresponding to the input depth image 210. A color of a foreground region 221 and a color of a background region 222 may be expressed differently.

In this example, due to a resolution difference, and the like, between the depth camera and the color camera, a resolution of the input depth image 210 may be different from a resolution of the input color image 220. In addition, due to inaccurate matching of a position or a direction between the depth camera and the color camera, the input depth image 210 and the input color image 220 may not accurately match pixel by pixel.

In this example, if needed, image matching between the input depth image 210 and the input color image 220, may be initially performed. However, detailed description related thereto will be omitted here. Hereinafter, it is assumed that the input depth image 210 and the input color image 220 accurately match with respect to the same second view.

The image warping unit 110 of the image processing apparatus 100 may perform depth based image warping. For example, the image warping unit 110 may shift the foreground region 221 of the input color image 220 based on a depth value of the input depth image 210 and a distance between the first view and the second view, for example, a distance between cameras. The first view may correspond to a target view at which a view transformed image is desired to be generated. For example, when the second view corresponds to a right eye view, the first view may correspond to a left eye view.

In the depth based image warping, more significant shifting may be performed as the depth value increases, that is, as the distance from the second view becomes closer. This is because a disparity according to a view difference increases as a distance from a view becomes closer.

In the case of the background region 222, shifting may be omitted or be significantly small due to a small disparity.

Hereinafter, a process of warping the input color image 220, based on a depth using the input depth image 210, captured at the second view, and then inpainting an occlusion region within a warped color image, will be described with reference to FIG. 3.

FIG. 3 illustrates a warped color image 300 including an occlusion region disoccluded by warping the color image of FIG. 2, according to an example embodiment.

The color image 300 warped by the imaging warping unit 110 may include a shifted foreground region 310, a background region 320, and occlusion regions 331 and 332.

Each of the occlusion regions 331 and 332 corresponds to a background region occluded behind the foreground region 310, and thus, has no color information.

The occlusion regions 331 and 332 may need to be corrected during a process of generating a first view color image by warping a 2D color image and generating a stereoscopic image or a multi-view image.

Here, as an example, color inpainting may be used. The color inpainting may be a process of selecting a suitable color to be applied to the occlusion regions 331 and 332 from color information within the existing input color image 220, and filling the occlusion regions 331 and 332 with the selected color.

According to a conventional method, color inpainting may be performed by copying and filling the occlusion regions 331 and 332 with color values of neighboring pixels of the occlusion regions 331 and 332 based on a block unit having a predetermined size or shape. However, in this example, instead of accurately reflecting actual object information, and thereby selecting only a color of the background region 320, a color of the foreground region 310 may be copied to the occlusion regions 331 and 332. As a result, an error may occur in a result image.

In the case of the occlusion region 331, both the left and right of the occlusion region 331 correspond to a portion of the foreground region 310. Therefore, when copying a color of left pixels or when copying a color of right pixels, even a portion that is to be filled with the color of the background region 320 may be filled with the color of the foreground region 310. As a result, an error may occur in a result image.

According to an embodiment, the boundary detector 120 of the image processing apparatus 100 may detect a boundary of each of the occlusion regions 331 and 332, the boundary labeling unit 130 may determine whether the determined boundary corresponds to a boundary that contacts with the foreground region 310 or a boundary that contacts with the background region 332, and thereby performs labeling. The boundary extraction, according to the present embodiment, will be further described with reference to FIG. 4, and the boundary labeling will be described with reference to FIG. 5 and FIG. 8.

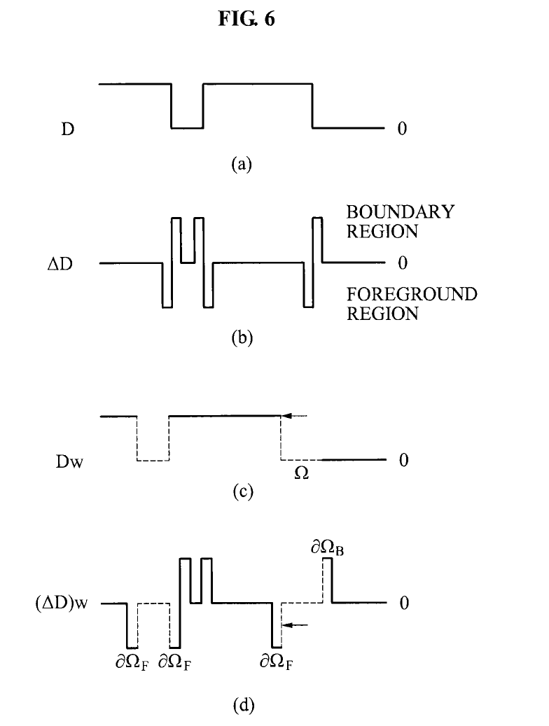

According to another example embodiment, the boundary detector 120 may generate a differentiated image by applying a secondary differential operator to the input depth image 210 corresponding to the second view, and may detect a boundary of an occlusion region using the differentiated image. Further detailed description related thereto will be made with reference to FIG. 6.

FIG. 4 illustrates a result of the image processing apparatus 100 extracting a boundary of an occlusion region from the warped color image of FIG. 3, according to an example embodiment.

The boundary extractor 120 may detect a boundary of each of the occlusions 331 and 332 using a conventional morphological operation process or chain code process.

The morphological operation process may set, as a predetermined margin, a boundary of an occlusion region in which a color value is absent, based on a gradient of a color value of each pixel of the warped color image 300. The chain code process may extract the boundary of the occlusion region by connecting pixels of a sampled boundary portion using a chain along a predetermined direction and thereby expanding the boundary. Both the morphological operation process and the chain code process are well known to those skilled in the art.

Referring to FIG. 4, the boundary of the occlusion region 331 is extracted as a boundary 410 and the boundary of the occlusion region 332 is extracted as a boundary 420, using the boundary extractor 120.

FIG. 5 illustrates an image to describe a process of the image processing apparatus labeling the boundary of the occlusion region of FIG. 4, according to an example embodiment.

According to an example embodiment, the boundary labeling unit 130 may determine whether a corresponding boundary corresponds to a boundary with the foreground region 310 and a boundary with the background region 320, and thereby perform labeling with respect to each of the extracted boundaries 410 and 420.

According to an example embodiment, the boundary labeling unit 130 may compute a gradient vector of a depth value with respect to each of the boundaries 410 and 420, using the input depth image 210. The gradient vector of the depth value may be integrally computed with respect to the whole input depth image 210 and be selectively used for each of the boundaries 410 and 420, or may be selectively computed with respect to only a portion of the boundaries 410 and 420 during a boundary labeling process.

The boundary labeling unit 130 may compute an occlusion direction vector towards the inside of the boundaries 410 and 420 of the occlusion regions 331 and 332.

In a boundary portion 510 that makes contact with the foreground region 310, a gradient vector 510 of a depth value and an occlusion direction vector 512 may face opposite directions. On the contrary, in a boundary portion 520 that makes contact with the background region 320, a gradient vector 521 of a depth value and an occlusion region vector 522 may face similar directions.

According to an example embodiment, the boundary labeling unit 130 may compute an inner product between a gradient vector of a depth value and an occlusion direction vector with respect to each of the boundaries 410 and 420.

In a portion where the computed inner product has a negative value, an angle between the gradient vector and the occlusion direction vector may need to be at least 90 degrees, and thus, the boundary labeling unit 130 may label a boundary of the corresponding portion with a boundary that makes contact with the boundary region 310.

On the contrary, in a portion where the computed inner product has a positive value, the angle between the gradient vector and the occlusion direction vector may need to be less than 90 degrees, and thus, the boundary labeling unit 130 may label a boundary of the corresponding portion with a boundary that makes contact with the background region 320.

According to another example embodiment, the boundary labeling unit 130 may identify a depth value within the non-warped input depth image 210, corresponding to each portion of the occlusion regions 331 and 332, and may compare the identified depth values with depth values outside the occlusion regions 331 and 332 in a warped depth image (not shown).

When a depth value of a non-warped depth image, corresponding to an inside of an occlusion region is less than a neighboring depth value of a warped depth image, the boundary labeling unit 130 may label a corresponding boundary with the boundary that makes contact with the foreground region 310 and otherwise, may label the corresponding boundary with the boundary that makes contact with the foreground region 310.

During the above process, the boundary labeling unit 130 may adaptively perform labeling based on noise within the input depth image 210, or an error occurring during other computation processes. Otherwise, the changing frequency of boundary labeling may be very high, which may result in causing an error.

According to an embodiment, when performing labeling with respect to a first point in an extracted boundary, the boundary labeling unit 130 may use an inner product computed for the first point, a result obtained from depth value comparison, and labeling with respect to a neighboring point of the first point. An outlier separate from a labeling result of the neighboring point may occur due to a noise error or a computation error. In this example, labeling of a neighbor portion may be applied as is.

Even though the embodiment describes that the boundary labeling unit 130 computes the gradient vector and thereby determines whether a corresponding boundary is the boundary that contacts with the foreground region 310 or the boundary that makes contact with the background region 320, it is only an example.

According to another embodiment, the boundary labeling unit 130 may determine whether the corresponding boundary is the boundary that makes contact with the foreground region 310 or the boundary that contacts with the background region 320 by applying a secondary differentiation to an input depth image, for example, by applying a Laplacian operator to the input depth image and warping the same. The embodiment will be further described with reference to FIG. 6.

FIG. 6, parts (a), (b), (c), and (d) illustrate a process of the image processing apparatus labeling the boundary of the occlusion region of FIG. 4, according to another example embodiment.

In the present embodiment, the boundary labeling unit 130 may apply a Laplacian operator to the original input depth image 210 to which a view transformation is not performed. Here, the Laplacian operator corresponds to a secondary differential operator.

The boundary labeling unit 130 may determine whether a corresponding boundary portion is a foreground region boundary or a background region boundary, using a sign of each pixel in a secondary differentiated image that is obtained by applying the secondary differential operator to the input depth image 210.

For example, when a pixel value in the secondary differentiated image is negative, the boundary labeling unit 130 may determine the corresponding boundary portion as the foreground region boundary, for example, a falling edge. On the contrary, when the pixel value is positive, the boundary labeling unit 130 may determine the corresponding boundary portion as the background region boundary, for example, a rising edge.

Depth-based warping may be performed with respect to the secondary differentiated image, which is the same as a view transformation of the input color image 220. In this example, even a secondary differentiation value of each pixel may also be shifted.

Accordingly, the boundary labeling unit 130 may have information regarding whether each pixel of the warped color image before the view transformation was the foreground boundary, for example, the falling edge, or the background region boundary, for example, the rising edge, and may determine whether each of the boundary regions 410 and 420 within the warped color image 300 is the foreground region boundary or the background region boundary using the information.

FIG. 6, parts (a), (b), (c), and (d) conceptually illustrate a process of performing the above process with respect to a one-dimensionally (1D) arranged depth value to help understand the 2D differential operation.

For the exemplary description, the depth value is simplified into two levels, 1 and 2, and [1, −2, 1] is employed for a differential operator.

Part (a) of FIG. 6 illustrates a 1D depth value of an original input depth image before a view transformation. In a level of a simplified depth value D, a portion with depth value ‘1’ corresponds to a foreground region and a portion with depth value ‘0’ corresponds to a background region.

According to the present embodiment using the differential operator, part (b) of FIG. 6 illustrates a result of generating a differentiation value ΔD by applying, using the boundary labeling unit 130, the differential operator [1, −2, 1] with respect to depth values of part (a).

Referring to part (b), in a boundary portion that belongs to the foreground region and also makes contact with the background region, the differentiation value ΔD is ‘−1’. In a boundary region that belongs to the background region and also makes contact with the foreground region, the differentiation value ΔD is ‘1’.

Part (c) of FIG. 6 illustrates a depth value D that is warped to D_{w}, according to the view transformation. In this example, the differentiation value ΔD may also be warped. The warped (ΔD)_{w} of the differentiation value ΔD is shown in part (d) of FIG. 6.

A portion indicated by a dotted line in a warped result corresponds to an occlusion region and the image processing apparatus may fill the occlusion region with a color value.

The above descriptions uses 1D as an example and the secondary differential operator, for example, [ 0 1 0; 1 −4 1; 0 1 0] may be used for an actual image.

In the case of an actual application, when a difference between depth values is insignificant, or when a depth value is inaccurate due to noise of the depth value, an accurate boundary segmentation may not be performed using only the secondary differentiation result.

In this example, an accurate robust result may be obtained using Laplacian of Gaussian (LoG), and the like.

An exemplary equation using LoG may be expressed by Equation 1.

$$LoG {=}^{Δ} Δ {G}_{σ} ( x , y ) = \frac{{\partial }^{2}}{\partial {x}^{2 }} {G}_{σ} ( x , y ) + \frac{{\partial }^{2}}{\partial {y}^{2}} {G}_{σ} ( x , y ) = \frac{{x}^{2} + {y}^{2} - 2 {σ}^{2}}{{σ}^{4}} {e}^{- ( {x}^{2} + {y}^{2} ) / 2 {σ}^{2}} \qquad Equation 1$$

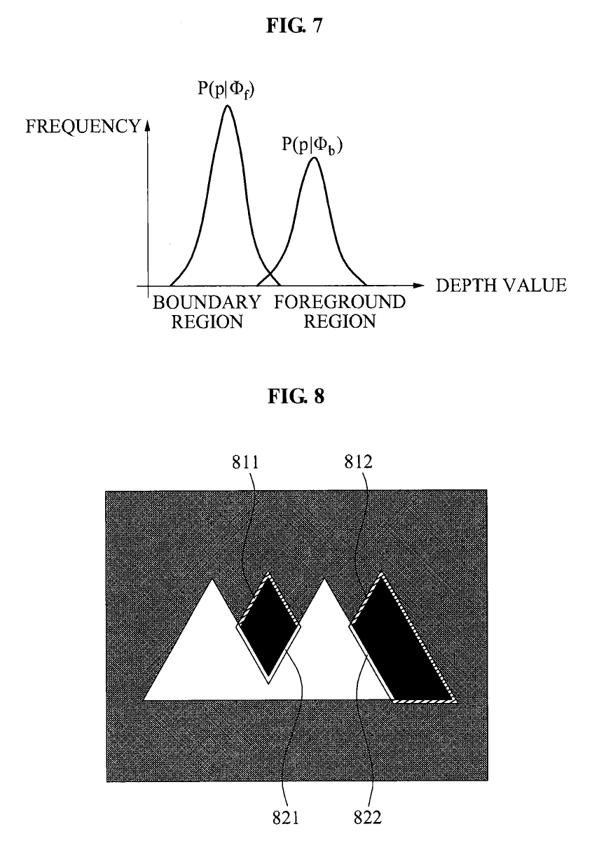

The boundary detector 120 may employ a probability distribution model in order to extract an accurate boundary value, which will be further described with reference to FIG. 7.

FIG. 7 illustrates a graph to describe a process of determining a boundary value of an occlusion region, according to an example embodiment.

A variety of methods may be used to remove an outlier using a depth value. One of the methods may include a method of using a probability distribution.

Since a depth value distribution is similar in neighboring portions, a probability model of being a foreground region and a probability model of being a background region may be generated using a depth histogram of a pixel that belongs to the foreground region and a depth histogram of a pixel that belongs to the background region.

An adjacent region may be segmented into the foreground region and the background region using the probability model. Also, a Markov random field (MRF) model, as expressed by Equation 2, may be used for more accurate segmentation, and optimization may be performed using a graph cut.

$$E ( l ) = {\sum }_{p ∈ Ω} {D}_{p} ( {l}_{p} ) + {\sum }_{\{ p , q \} ∈ N} {V}_{p , q} ( {l}_{p} , {l}_{q} ) \qquad Equation 2$$

In Equation 2, Dₚ(lₚ) denotes a data term of the depth value, and V_{pq}(lₚ, l_{q}) denotes a smooth term. Dₚ(lₚ) and V_{pq}(lₚ, l_{q}) may be defined using Equation 3 and Equation 4, respectively.

$$\begin{matrix}{D}_{p} ( {l}_{p} ) = \{ \begin{matrix}- log P ( p \vert {Φ}_{f} ) & if {l}_{p} = {Φ}_{f} \\ - log P ( p \vert {Φ}_{b} ) & if {l}_{p} = {Φ}_{b}\end{matrix} & Equation 3 \\ V ( {l}_{p} , {l}_{q} ) = λ \vert {l}_{p} - {l}_{q} \vert & Equation 4\end{matrix}$$

In an embodiment of using a gradient vector, not an embodiment of applying a differential operator, a method of considering a result of an inner production computation of the gradient vector to be more reliable according to an increase in a vector value, may be employed. For example, the result may be more reliable as a norm of an inner product value increases.

The boundary labeling unit 130 may enhance the reliability of the labeling process according to various embodiments.

FIG. 8 illustrates an image in which labeling is performed with respect to a boundary of an occlusion region, according to an example embodiment.

Using the boundary labeling unit 130, a boundary portion that makes contact with the background region 320 is labeled with boundaries 811 and 812, and a boundary portion that contacts with the foreground region 310 is labeled with boundaries 821 and 822.

FIG. 9 illustrates an image to describe a process of the image processing apparatus 100 determining a color inpainting direction, according to an example embodiment.

The inpainting direction determining unit 140 of the image processing apparatus 100 may determine a color inpainting direction from a direction of the boundaries 811 and 812 that are labeled with the boundary with the background region 320 to a direction of the boundaries 821 and 822 that are labeled with the boundary with the foreground region 310.

FIG. 9 illustrates color inpainting directions 910 and 920, determined as above.

In this example, the inpainting direction may be dynamically changed for each boundary portion.

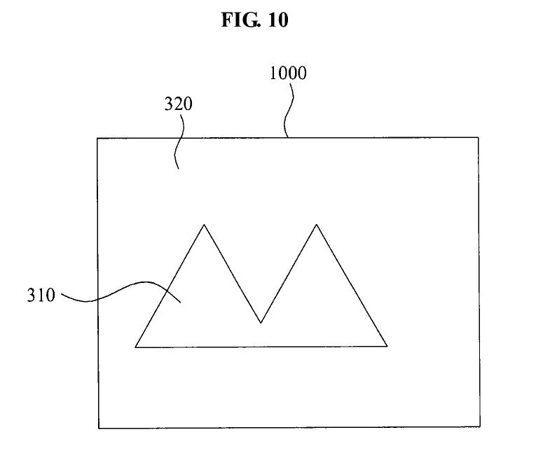

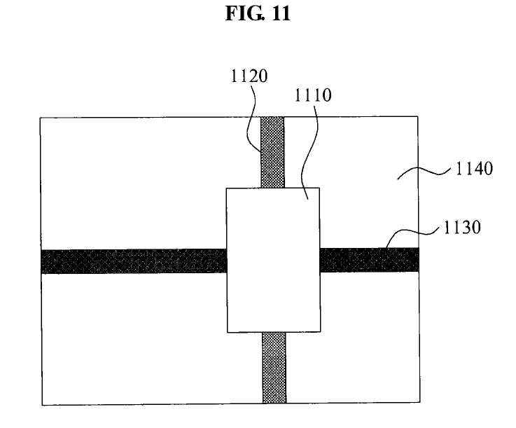

FIG. 10 illustrates a result image 1000 of color inpainting with respect to the occlusion region of the warped color image of FIG. 3, according to an example embodiment.

The color inpainting unit 150 of the image processing apparatus 100 may copy a color value and fill the occlusion region with the color value, along an inpainting direction that is determined by the inpainting direction determining unit 140. Accordingly, inpainting of the occlusion regions 331 and 332 may be performed using color values of the background region 320.

The result image 1000 corresponds to a result image in which color of the occlusions 331 and 332 is recovered. The result image 1000 corresponds to a first view that is a target view at which the result image 1000 is desired to be generated. For example, the result image 1000 may correspond to a left eye image.

The result image 1000 may be provided together with the input color image 220 corresponding to a right eye image, so that a viewer may experience a 3D effect.

FIG. 11 illustrates a color image that is inputted into the image processing apparatus 100, according to an example embodiment.

Depending on a characteristic of an input image, inpainting of an occlusion region may need to be performed using color values corresponding to a plurality of layers.

For example, in the case of the color image of FIG. 11, foreground regions are positioned from a view in an order of a first foreground region 1110, a second foreground region 1120, a third foreground region 1130, and a background region 1140.

In the case of the color image that includes a plurality of layers, even though color inpainting is performed along an inpainting direction that is determined through boundary detection and labeling with respect to an occlusion region within a warped color image, an error may occur in an overlapping portion of the layers.

Accordingly, even though the color inpainting direction is determined by the inpainting direction determining unit 140, the inpainting unit 150 may perform inpainting by varying orders of corresponding portions.

This process will be described with reference to FIG. 12

FIG. 12 illustrates a process of inpainting an occlusion region of a warped color image corresponding to the color image of FIG. 11, according to an example embodiment.

An occlusion region in black is disclosed in a warped color image 1210. This is because the first foreground region 1110 is shifted.

In this example, a process in which the boundary detector 120 detects a boundary, the boundary labeling unit 130 separately labels a boundary with the first foreground region 1110 and a boundary with other regions, and the inpainting direction determining unit 140 determines an inpainting direction is similar to the aforementioned description.

However, the inpainting unit 150 may initially perform inpainting using a color value of a portion in which the edge strength of a color value or a depth value is high, a color value of a portion that is determined to be close to a view through a depth value of an input depth image, and a color value of a portion that is close to an extracted boundary.

According to the above principle, in an intermediate result image 1220, inpainting is performed using a color value of the second foreground region 1120. In an intermediate result image 1230, inpainting is subsequently performed using a color value of the third foreground region 1130. During the inpainting process, a portion that is already inpainted, and thereby has a color value, may be skipped.

In a result image 1240, inpainting is also performed using a color value of the background region 1140, whereby the occlusion region in black within the warped color image 1210 is all recovered.

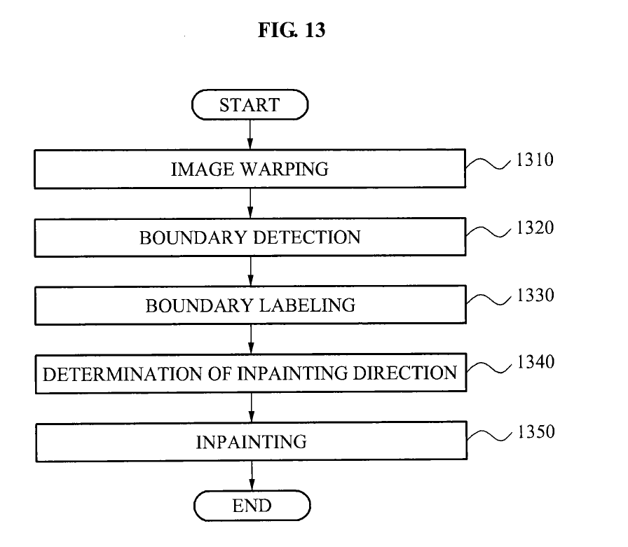

FIG. 13 illustrates an image processing method, according to an example embodiment.

In operation 1310, the image warping unit 110 of the image processing apparatus 100 may warp an input color image corresponding to a second view to correspond to a first view. Image warping is described above with reference to FIG. 2 and FIG. 3.

When image warping is performed, an occlusion region may be disoccluded as shown in FIG. 3.

In operation 1320, the boundary detector 120 of the image processing apparatus 100 may detect a boundary of the occlusion region. The boundary detection process is described above with reference to FIG. 4.

In operation 1330, the boundary labeling unit 130 of the image processing apparatus 100 may determine whether a corresponding portion corresponds to a boundary with a foreground region or a boundary with a background region, and thereby perform labeling with respect to each portion of the boundary. Embodiments of a method using a depth value comparison, a determining method using an inner product between a gradient vector of a depth value and an occlusion direction vector, and the like, during the above process are described above with reference to FIG. 5 through FIG. 8.

In operation 1340, the inpainting direction determining unit 140 of the image processing apparatus 100 may determine an inpainting direction from a direction of the boundary that makes contact with the background region to a direction of the boundary that makes contact with the foreground region. The inpainting direction determining method is described above with reference to FIG. 9.

In operation 1350, the inpainting unit 150 of the image processing apparatus 100 may perform color inpainting along the determined inpainting direction. During this process, a method of expressing a plurality of layers within the occlusion region by varying a priority of color inpainting in each boundary region is described above with reference to FIG. 11 and FIG. 12.

The image processing method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Further, according to an aspect of the embodiments, any combinations of the described features, functions and/or operations can be provided.

Moreover, the image processing apparatus may include one or more processors.

Although embodiments have been shown and described, it would be appreciated by those skilled in the art that changes may be made in these embodiments without departing from the principles and spirit of the disclosure, the scope of which is defined by the claims and their equivalents.

1. An image processing apparatus, comprising:
a boundary detector to detect a boundary of an occlusion region of a color image warped in correspondence to a first view; and
a boundary labeling unit to label the detected boundary with one of a foreground region boundary and a background region boundary.

2. The image processing apparatus of claim 1, further comprising:
an image warping unit to shift at least a portion of an input color image, corresponding to a second view, using an input depth image, corresponding to the second view, and to provide the warped color image to the boundary detector.

3. The image processing apparatus of claim 2, wherein the boundary labeling unit secondarily differentiates the input depth image, and labels the detected boundary of the occlusion region of the warped color image with one of the foreground region boundary and the background region boundary, based on a result of the secondary differentiation.

4. The image processing apparatus of claim 3, wherein the boundary labeling unit employs a Laplacian operator when secondarily differentiating the input depth image.

5. The image processing apparatus of claim 3, wherein the boundary labeling unit labels the detected boundary of the occlusion region of the warped color image with one of the foreground region boundary and the background region boundary, depending on whether the boundary of the occlusion region corresponds to a falling edge or a rising edge, based on the result of the secondary differentiation.

6. The image processing apparatus of claim 2, wherein the boundary labeling unit labels the detected boundary with one of the foreground region boundary and the background region boundary, using an inner product between a gradient vector of the input depth image and an occlusion direction vector of the warped color image.

7. The image processing apparatus of claim 6, wherein the boundary labeling unit labels at least a portion of the detected boundary corresponding to a negative inner product as the foreground region boundary, and labels at least a portion of the detected boundary corresponding to a positive inner product as the background region boundary.

8. The image processing apparatus of claim 6, wherein the boundary labeling unit increases a reliability weight of the inner product, according to an increase in at least one scalar value, among the gradient vector of the input depth image and the occlusion direction vector of the warped color image.

9. The image processing apparatus of claim 6, wherein the boundary labeling unit increases a reliability weight according to an increase in a similarity between an inner product that is computed in correspondence to a first point in the detected boundary and an inner product that is computed in correspondence to a neighboring point of the first point.

10. The image processing apparatus of claim 1, further comprising:
an inpainting direction determining unit to determine an inpainting direction of the occlusion region of the warped color image from a direction of the background region boundary to a direction of the foreground region boundary, based on the labeling result with respect to the boundary of the occlusion region of the warped color image.

11. The image processing apparatus of claim 10, further comprising:
an inpainting unit to generate a result color image in which a color value of the occlusion region of the warped color image is recovered by performing color inpainting along the determined inpainting direction.

12. The image processing apparatus of claim 10, wherein the inpainting direction determining unit determines the inpainting direction based on at least one of an edge strength of the detected boundary, a depth value of the input depth image corresponding to the occlusion region of the warped color image, and a distance from the detected boundary of the occlusion region of the warped color image.

13. The image processing apparatus of claim 1, wherein the boundary detector detects the boundary of the occlusion region of the warped color image using a morphological operation.

14. The image processing apparatus of claim 1, wherein the boundary detector detects the boundary of the occlusion region of the warped color image using a chain code process.

15. The image processing apparatus of claim 1, wherein the boundary detector detects the boundary of the occlusion region of the warped color image using a secondary differentiation result of an input depth image.

16. An image processing method, comprising:
detecting a boundary of an occlusion region of a color image warped in correspondence to a first view; and
labeling the detected boundary with one of a foreground region boundary and a background region boundary.

17. The method of claim 16, further comprising:
shifting at least a portion of an input color image corresponding to a second view using an input depth image corresponding to the second view, prior to the detecting, to provide the warped color image to the boundary detector.

18. The method of claim 17, wherein the labeling comprises secondarily differentiating the input depth image, and labeling the detected boundary of the occlusion region of the warped color image with one of the foreground region boundary and the background region boundary, based on a result of the secondary differentiation.

19. The method of claim 17, wherein the labeling comprises labeling the detected boundary with one of the foreground region boundary and the background region boundary, using an inner product between a gradient vector of the input depth image and an occlusion direction vector of the warped color image.

20. An image processing method, comprising:
detecting a foreground boundary and a background boundary from an input depth image; and
segmenting the input depth image into a foreground region and a background region using at least one depth value of the foreground boundary and the background boundary or a depth value histogram thereof.

21. The method of claim 20, further comprising:
warping an input color image, which is associated with the input depth image and corresponds to a first view, from the first view to a second view different from the first view; and
recovering an occlusion region occurring during the warping process using at least one pixel value that belongs to the background region by identifying, from the labeling result, at least one background region in the input color image corresponding to the first view and the input color image warped to the second view.

22. A non-transitory computer-readable medium comprising a program for instructing a computer to perform the method, according to one of claims 16 through 21.

23. The apparatus of claim 2, wherein the first view corresponds to a left eye view and the second view corresponds to a right eye view.

24. The method of claim 17, wherein the first view corresponds to a left eye view and the second view corresponds to a right eye view.

25. The method of claim 21, wherein the first view corresponds to a left eye view and the second view corresponds to a right eye view.
